(19) United States
(12) Patent Application Publication
(10) Pub. No.: US 2026/0260032 A1
(43) Pub. Date: Sep. 3, 2026

(54) TAPERING METHOD AND SYSTEM

(71) Applicant: Siemens Industry Software Inc., Plano, TX (US)

(72) Inventors: John Eisenlohr, Cincinnati, OH (US); Tamara Galor, Cambridge (GB)

(21) Appl. No.: 19/067,584

(22) Filed: Feb. 28, 2025

(51) Int. Cl. G06F 30/17

(52) U.S. Cl. CPC G06F 30/17

(57) ABSTRACT

A method and a system of modifying a mesh to satisfy a taper constraint are described. The method includes accessing a representation of an object as a mesh, sorting vertices of the mesh into a height-ordered list based on a distance from a parting surface, adjusting positions of one or more of the vertices, and iteratively repeating the adjusting of positions of vertices until the mesh satisfies the taper constraint.

### TECHNICAL FIELD

The present disclosure relates to methods and systems for modifying a mesh, and, in particular, for modifying a mesh to satisfy a taper constraint for a molding process.

### BACKGROUND

Topology optimization is used in many different areas of technology including aerospace, automotive, and biomedical engineering, as well as product design, to find the most efficient design of an object subject to a set of constraints. Topology optimization may be used to reduce the weight of an object, maximize the strength of an object, or to reduce material use, while achieving desired structural constraints such as stress limits, material constraints such as material volume or weight limits, or functional constraints such as assembly fit, or boundary conditions.

Topology optimization begins with an input including one or more design constraints, an objective function, and a design domain. A structure is initially represented as a mesh in the design domain. The mesh includes a subdivision of space into discrete geometric and topological cells called facets. Finite element analysis is applied to the mesh to evaluate the performance of the structure it represents. The output is an optimized material distribution in the design domain, also represented as a mesh. Topology optimization workflows may be integrated in a computer-aided design (CAD) system.

One aspect of topology optimization is the ability to consider the desired form of manufacturing when optimizing the shape, to provide that the manufactured part will match the design. While some parts are manufactured using additive manufacturing techniques, many other parts are created using molding techniques. There are a variety of molding techniques such as extrusion molding, injection molding, compression molding, blow molding, die casting and vacuum forming, and many others. The method of molding that is selected to manufacture a part may depend on the type of materials being used and the type and design of the part.

In order to enable a part to be extracted from a mold with ease, molded parts are to satisfy a taper constraint. The taper constraint specifies a parting surface, a taper angle, and a pull direction vector. The parting surface refers to a surface that separates the mold in two halves, allowing the part to be ejected. The taper or draft angle refers to an incline designed into the vertical walls of a mold, allowing a finished part to be extracted with ease. The pull direction vector refers to the direction the mold is pulled away from the part. The taper constraint specifies that the angle between a normal vector on the surface of the part and the pull direction is to be less than ninety degrees minus the taper angle. When this condition is satisfied, there are no steep-sided or overhanging portions, and the part is removable from the mold with ease.

Some methods of topology optimization utilize a voxel representation and generate the resulting meshes from the voxel data. In the case of molded parts, the taper angles involved are often small angles and cannot be captured adequately by the voxelization at an accuracy sufficient to produce meshes that satisfy the draft condition. The angle variation between the facet normal and pull direction caused by the choice of triangulation may be larger than the draft angles involved. Without any further modification to the mesh, such a mesh may become unmanufacturable using a mold, as the molded part may not be removable from the mold.

This provides that that parts that initially appear suitable for molding may in fact require substantial downstream work to make them usable. This is not only difficult and costly, but also risks invalidating the topology optimized aspects of the mesh that have already occurred. For example, one method used in CAD involves adding a tapered skirt of material over any steep regions of the part, which may noticeably change its weight and performance, undoing the benefit of topology optimization.

### SUMMARY AND DESCRIPTION

There is a need for a method of modifying a mesh to satisfy a draft condition for molding, while also honoring the results of topology optimization. According to a first aspect, a computer-implemented method of modifying a mesh to satisfy a taper constraint for a molding process is provided. The taper constraint specifies a draft angle, θ, and a pull direction vector relative to a parting surface. The method includes steps of a) accessing a representation of an object as a mesh in three-dimensional space, the mesh including a plurality of interconnected vertices forming one or more facets; b) sorting the plurality of vertices into a height-ordered list, based on a distance of each vertex from the parting surface in the direction of the pull direction vector; c) adjusting a position of one or more of the vertices; and d) iteratively repeating step c) until the taper constraint is satisfied for every vertex in the mesh. Adjusting the position of one or more of the vertices includes steps of: i) selecting the first vertex in the ordered list as a first selected vertex; ii) determining whether the first selected vertex satisfies the taper constraint; iii) when the first selected vertex fails to satisfy the taper constraint, adjusting the position of the first selected vertex in a plane perpendicular to the pull direction vector and containing the first selected vertex; iv) selecting the subsequent vertex in the ordered list as a next selected vertex; and v) repeating steps ii)-iv) for the next selected vertex, until every vertex in the ordered list has been selected.

The method according to the first aspect enforces a taper constraint on a mesh by adjusting in small increments, the positions of vertices. The method iteratively adjusts positions of vertices based on a height from the parting surface. The method repeatedly iterates over the vertices. This helps to provide that the adjustment in each iteration does not distort the mesh so that the topology optimization of the mesh is respected.

In a first implementation form of the method according to the first aspect, determining whether a selected vertex, v, satisfies the taper constraint includes determining whether a height of the selected vertex, v, above the parting surface is above a predefined threshold; applying a first method to determine whether the selected vertex, v, satisfies the taper constraint, when the height of the selected vertex, v, is above the predetermined threshold; and applying a second method to determine whether the selected vertex, v, satisfies the taper constraint, when the height of the selected vertex, v, is below the predetermined threshold.

In a second implementation form the first method to determine whether the selected vertex, v, satisfies the taper constraint includes: generating a set of taper planes for the selected vertex, v; for each taper plane in the set of taper planes, determining whether the selected vertex v satisfies the taper constraint for the taper plane; identifying the selected vertex, v, as failing the taper constraint when the selected vertex, v, fails the taper constraint for one or more of the taper planes in the set, and otherwise, identifying the selected vertex as satisfying the taper constraint.

In a third implementation, generating the set of taper planes for the selected vertex, v, includes: identifying facets in the mesh located below the selected vertex, v, with respect to the pull direction vector; and for each identified facet, identifying one or more edges of the facet, constructing a plane containing the edge, based on the draft angle, θ, and including the plane in the set of taper planes for the selected vertex, v.

In a fourth implementation form, adjusting the position of the selected vertex, v, includes: intersecting each taper plane with the plane perpendicular to the pull direction vector and containing the selected vertex, v, to obtain a line; including the line in a set of lines, L; identifying a target position, v′, for the selected vertex, v, based on the set of lines, L; and adjusting the position of the selected v, in a direction, v′-v, towards the target position, v′.

In a fifth implementation form, adjusting the position of the selected vertex, v, includes: adjusting the position by a fraction, 1/c, of the direction, v′-v, towards the target position v′, for a predefined constant value, c.

In a sixth implementation form, the second method to determine whether the selected vertex, v, satisfies the taper constraint includes: intersecting the parting sheet with the mesh to generate a set of parting curves; obtaining a set of taper surfaces, based on the set of parting curves; identifying a taper surface associated with the selected vertex, v; determining whether selected vertex v satisfies the taper constraint with respect to the associated taper surface; and identifying the selected vertex, v, as failing the taper constraint when the selected vertex, v, fails the taper constraint for the associated taper surface, and otherwise, identifying the selected vertex as satisfying the taper constraint.

In a seventh implementation form, adjusting the position of the selected vertex, v, includes: identifying a target position, v′, for the selected vertex, v, based on the associated taper surface; and adjusting the position of the selected v, in a direction, v′-v, towards the target position, v′.

In an eighth implementation form, adjusting the position of the selected vertex, v, includes: adjusting the position by a fraction, 1/c, of the direction, v′-v, towards the target position v′, for a predefined constant value, c.

In a ninth implementation form, obtaining a set of taper surfaces based on the set of parting curves includes, for each parting curve in the set of parting curves: sweeping a cone along the parting curve to obtain an envelope surface; and including the obtained envelope surface in the set of taper surfaces.

These and other aspects of the invention will be apparent from the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings, in which:

FIGS. 1A-1C show a mesh model, according to an example;

FIG. 2 is a flow diagram of a method of modifying a mesh to satisfy a taper constraint, according to an example;

FIGS. 3A-3E show a graphic representation of the modification to a mesh, according to an example;

FIGS. 4A-4B show a mesh model, according to an example;

FIGS. 5A-5F show a graphic representation of the modification to a mesh, according to an example; and

FIG. 6 illustrates an example of a data processing system in which embodiments of the present disclosure may be implemented.

### DETAILED DESCRIPTION

Example embodiments are described below in sufficient detail to enable those of ordinary skill in the art to embody and implement the systems and processes herein described. It is important to understand that embodiments may be provided in many alternate forms and should not be construed as limited to the examples set forth herein.

Accordingly, while embodiments may be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that the articles have a single referent; however, the use of the singular form in the present document should not preclude the presence of more than one referent. In other words, elements referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms including technical and scientific terms used herein are to be interpreted as is customary in the art. It will be further understood that terms in common usage should also be interpreted as is customary in the relevant art and not in an idealized or overly formal sense unless expressly so defined herein.

Methods and systems described herein are implemented in or in conjunction with a Computer-Aided Design (CAD) system. CAD systems enable the creation, modification, and analysis of a design of an object for manufacture. CAD software is used across many industries, including architecture, engineering, manufacturing, and product design. Modern CAD systems enable the creation of highly detailed two and three dimensional models and provide a vast array of modelling and design tools to enable designers to efficiently modify models without having to reconfigure an entire design by hand. CAD systems may integrate with other software tools, such as simulation software, product lifecycle management (PLM) systems, and computer-aided engineering (CAE) tools.

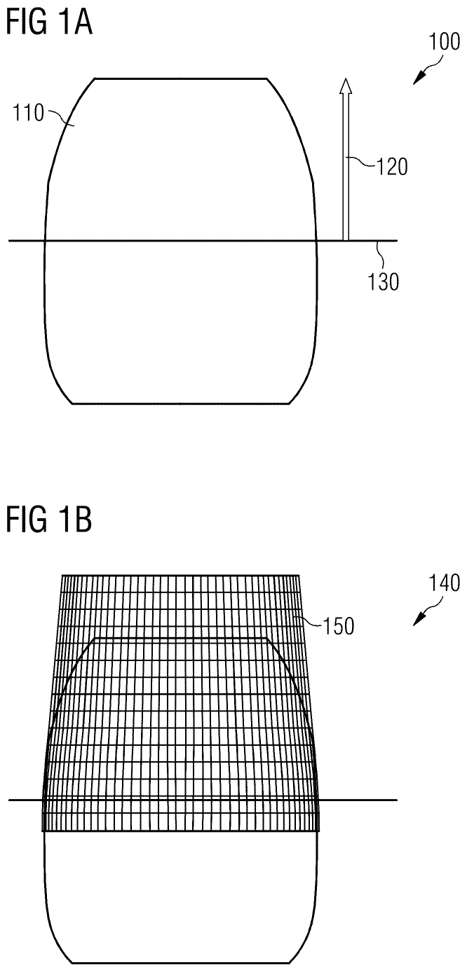

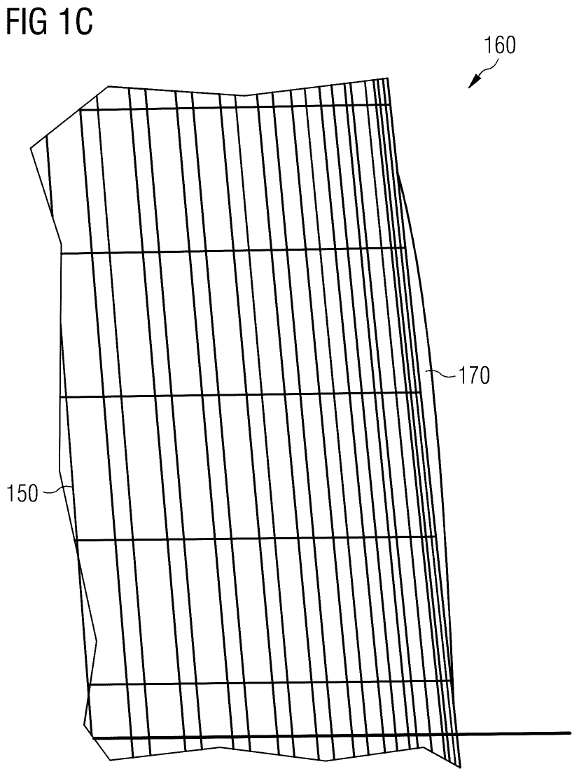

FIG. 1A is a diagram 100 showing a mesh 110 of a part intended for manufacture using a molding method. The mesh 110 may be an output obtained from the application of a topology optimization to a model of the part. The mesh 110 may be displayed in a user interface of a computer-aided design (CAD) system. The diagram 100 shows a pull direction vector 120 and parting surface 130. The pull direction vector 120 refers to the direction the mold is pulled away from the mesh 110. The parting surface 130 is a surface that separates the mold in two halves, allowing the mesh 110 to be ejected from the mold. In the example shown in FIG. 1A, the pull direction vector 120 corresponds to the Z-axis, and the parting surface 130 corresponds to the X-Y plane.

FIG. 1B is a diagram 140, showing the same mesh 110 as FIG. 1A. The diagram 140 shows a taper surface 150. The taper surface 150 is a surface that represents the taper condition that the mesh 110 is to satisfy in order to provide that the mesh 110 is removable from the mold in the molding process. In the example of FIG. 1B, the taper surface 150 is sloped at an angle equal to a draft angle of three degrees from the pull direction vector 120. In other examples, the draft angle may be more or less than three degrees.

A taper surface such as the taper surface 150 may be constructed by sweeping a cone along the parting curve, C. Without loss of generality, the pull direction vector may be assumed to be the Z-axis. For a point p in [symbol] ³ and a taper angle a, let D(p,a) be the cone with vertex p, angle a, and axis the Z-axis. A unit vector starting at p and lying in the cone may be expressed as R(φ)=(cos(φ)*sin(a), sin(φ)*sin(a),cos(a)). At any point of the line on the cone given by L(t)=p+t*R(φ), the normal vector to the cone is N(φ)=(cos(φ)*cos(a),sin(φ)*cos(a),−sin(a)).

A taper surface constructed on a parting curve C is the envelope surface formed by sweeping the cone D along C. The envelope includes the cone rulings along which the cone normal is perpendicular to the parting curve tangent. Assume that the parting curve is a parametric 3D curve C: [symbol] → [symbol] ³. Given C, a pull direction P and a taper angle a, the taper surface S is a parametric surface defined as S(u,v)=c(u)+v*R(φ(u)), where R is the unit vector on the cone along which the normal N(φ(u)) is perpendicular to T(u), the unit tangent of the parting curve. At a point C(u), if the X and Y axes are oriented so that T(u)=(cos(θ),0,sin(θ)), then the value φ for which dot product (cos(φ)*cos(a),sin(φ)*cos(a),−sin(a))·(cos(θ),0,sin(θ))=0 satisfies

$$cos ( φ ) = \frac{sin ( a ) sin ( θ )}{cos ( a ) cos ( θ )}$$

If θ=0 (e.g., the curve tangent T is perpendicular to the pull direction), then cos(φ)=0, so φ=90°, and the ruling is in the Y-Z plane. If sin(θ)>0 (e.g., T has a positive Z component), then cos(φ)>0, so φ<90°, and if T has a negative Z component, then cos(φ)<0, so φ>90°. If the parting curve is a line segment, the rulings are parallel along the length of the segment, and the taper surface is a plane.

FIG. 1C is a diagram 160 showing a portion of the mesh 110 from FIGS. 1A and 1B. Facets of the mesh 110 in a region 170 fall outside of the taper surface 150. The facets in region 170 prevent the part being removed from a mold as the facets do not satisfy the taper constraint. In order to make the mesh 110 manufacturable, the facets in region 170 are to be changed in order to satisfy the taper constraint, while also respecting the topology optimization that has already occurred.

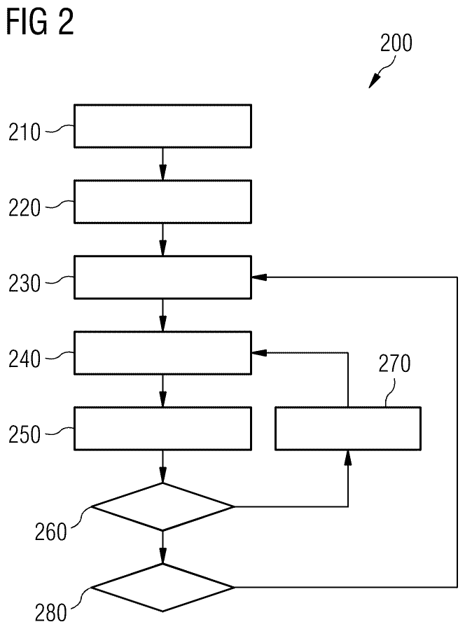

FIG. 2 is a flow diagram of a method 200 of modifying a mesh to satisfy a taper constraint for a molding process. The method 200 may be used to modify a mesh such as the mesh 110 shown in FIG. 1. The taper constraint is specified by a draft angle, θ, and a pull direction vector relative to a parting surface. The method 200 may be used in conjunction with topology optimization workflows implemented in a CAD or CAM system, for example. The method 200 may be used in conjunction with any molding processes where a taper constraint may be implemented.

Referring to FIG. 2, at block 210, a representation of an object as a mesh in three-dimensional space is accessed. In examples described herein, the mesh includes a plurality of interconnected vertices that form facets. The mesh may be the output of topology optimization applied to a part. The mesh data for the mesh may be stored in main memory of a data processing system that implements a modelling system. The mesh data may be loaded to the data processor for further processing in the modelling system. In other cases, the mesh data may be accessed or downloaded from a remote data storage via a network, for example.

At block 220, the plurality of vertices of the mesh are sorted into a height-ordered list. The sorting of the vertices is based on a distance of each vertex from the parting surface in the direction of the pull direction vector, from the vertices closest to the parting surface to those farthest from the parting surface. According to examples, if the pull direction vector P is aligned with the Z axis, and parting surface is the X-Y plane, the height of a vertex, v, from the parting surface may be determined by computing a vector dot product, v·P, where P is the pull direction vector, as this represents the component of v in the direction of P. The vertices may then be ordered based on dot products: for vertices v₁ and v₂, the vertex v₁ comes before v₂ when the dot product v₁·P is less than the dot product v₂·P.

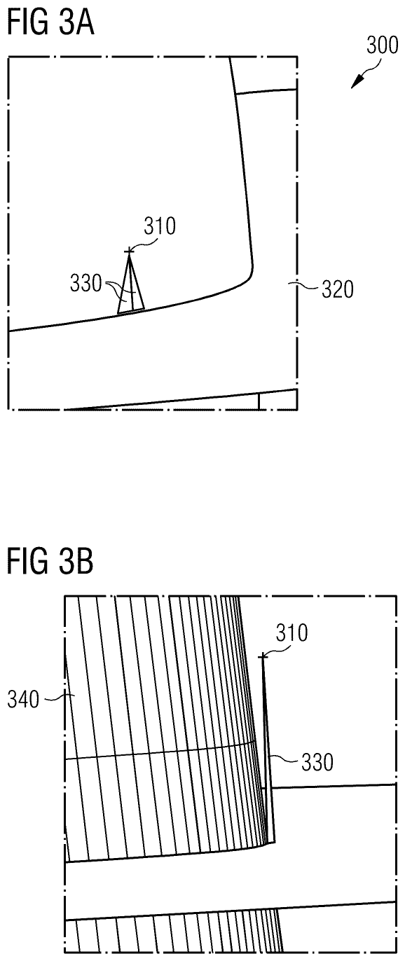

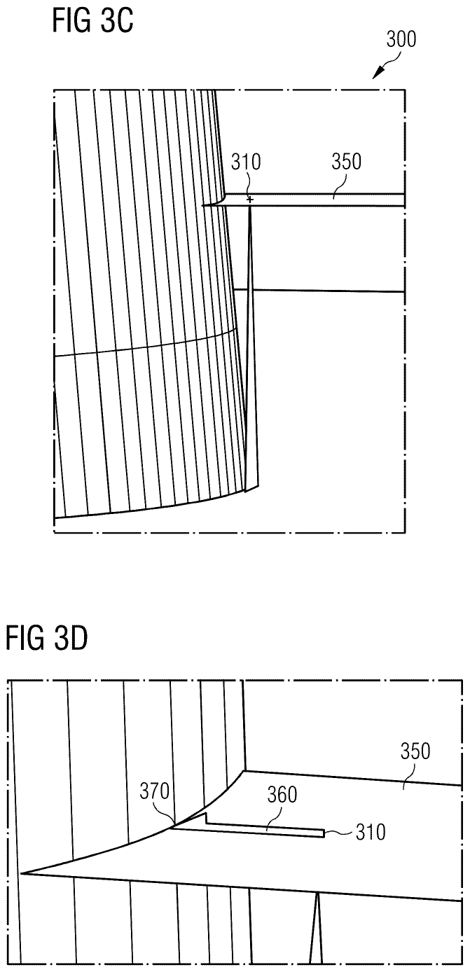

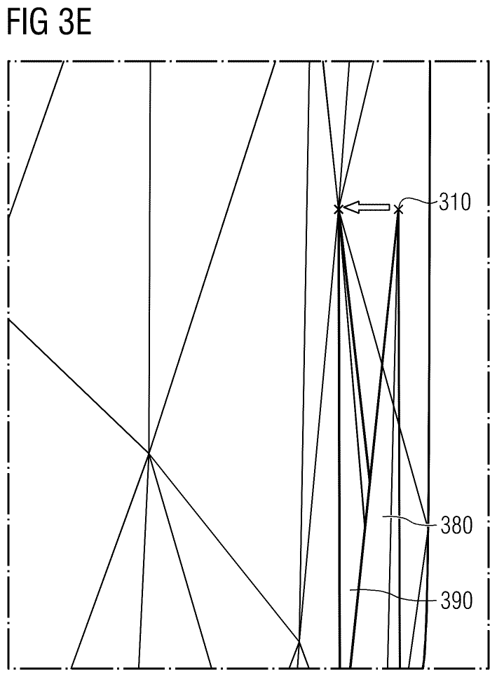

At block 230, the first vertex in the ordered list is selected as the first selected vertex. At block 240, a determination of whether the selected vertex satisfies the taper constraint is made. When a vertex is close to the parting surface, the determination of whether the vertex satisfies the taper constraint may be based on a comparison of a facet normal vector of a facet containing the vertex with a normal vector of a taper surface. FIG. 3A shows a portion 300 of mesh 110 from FIGS. 1A to 1C. In FIG. 3A, a vertex 310 of the mesh is located close to the parting surface 320. Facets 330 contains the vertex 310, and is located below the vertex 310.

FIG. 3B shows the same facets 330 in a side profile view and a taper surface 340. In order to determine whether the vertex 310 satisfies the taper constraint, the dot product of the facet normal vector of the facets 330, with the normal vector of the taper surface 340 may be computed. As the vertex 310 and facets 330 lie outside the taper surface, the value returned by this computation is positive.

Referring again to FIG. 2, at block 250, the position of the selected vertex is adjusted when the first selected vertex fails to satisfy the taper constraint. The position of the vertex is adjusted in a plane perpendicular to the pull direction vector that contains the vertex. FIG. 3C shows the portion of the mesh 300 from FIGS. 3A and 3B, and a plane 350 containing the vertex 310. The plane 350 is perpendicular to the pull direction vector, which is aligned with the Z-axis.

In examples described herein, a position of a vertex v that is close to the parting surface and does not satisfy the taper constraint, such as the vertex 310, may be adjusted by identifying a target position v′ in the plane, located on the associated taper surface. The position of the vertex v is adjusted in the plane, in a direction v′-v towards the taper surface. Adjusting the position of a vertex in the plane perpendicular to the pull direction vector containing the vertex provides that the ordering of the vertices, which is based on a dot product v. P of the vertex position with the pull direction vector, is unchanged by the adjustment.

FIG. 3D shows the direction vector 360 for adjusting the position of the vertex 310 towards a target position 370 on the taper surface 340. Moving a vertex by too great a distance in a single interaction may cause the mesh to distort. In order to respect topology optimized parts of the mesh, the position of the vertex may be adjusted by a fraction 1/c of the distance towards the target position v′, for some predefined constant c. For example, if the mesh is obtained from a marching cubes algorithm, the constant c may be based on the voxel size of the marching cubes algorithm. FIG. 3E shows a graphical representation of a single iteration of the method 200 as applied to the facets 330. The position of the facets before 380 and after 390 the adjustment are shown in FIG. 3E, as well as the position of the surrounding facets after the adjustment.

Referring to FIG. 2, at block 260, a determination of whether there are further vertices to select in the ordered list is made. If there are vertices in the ordered list that have not been selected, then, at block 270, the subsequent vertex in the ordered list is selected as a next selected vertex, and blocks 240-260 are repeated with the next selected vertex (e.g., a determination of whether the next selected vertex satisfies the taper constraint is made). When the next selected vertex does not satisfy the taper constraint, the position of the next selected vertex is adjusted in a plane perpendicular to the pull direction vector, containing the next selected vertex. If there are further vertices the process continues, and the subsequent vertex in the ordered list is selected as the next selected vertex.

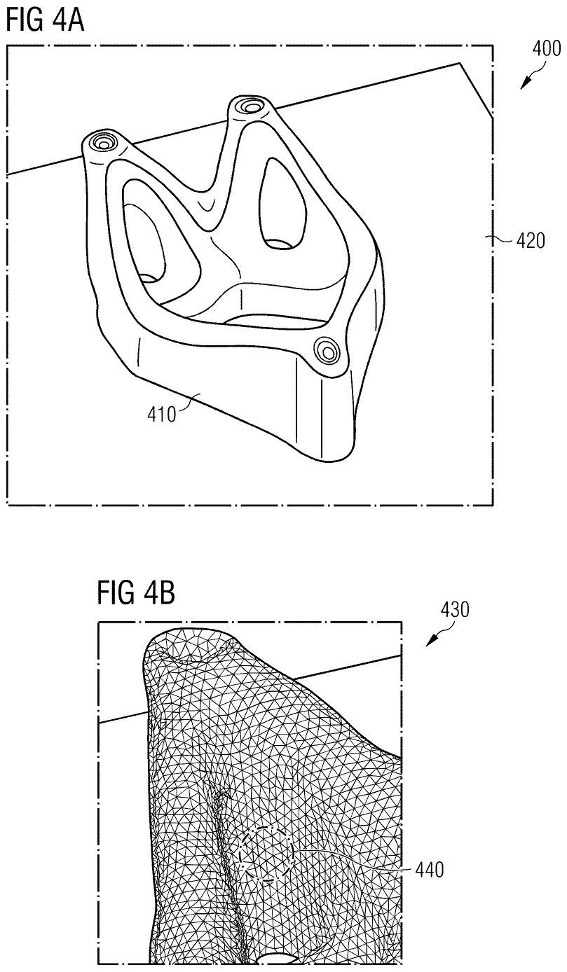

FIGS. 4A and 4B show a diagram 400 of a mesh 410 and parting surface 420. FIG. 4B shows an enlarged view 430 of the mesh 410. In the example shown in FIG. 4B, facets in a region 440 of the mesh 410 are in violation of the taper constraint. When a vertex is located close to the parting surface 420, a taper surface constructed on the parting curve (e.g., the intersection of the mesh 410 with the parting surface 420) may be used to determine whether the vertex satisfies the taper constraint, as previously described in the context of the mesh 110. However, for vertices located further away from the parting surface such as the vertices in the region 440, a different method is used to identify and adjust positions of the vertices that do not satisfy the taper constraint. In examples described herein, this alternative method may be used for vertices above a threshold height from the parting surface.

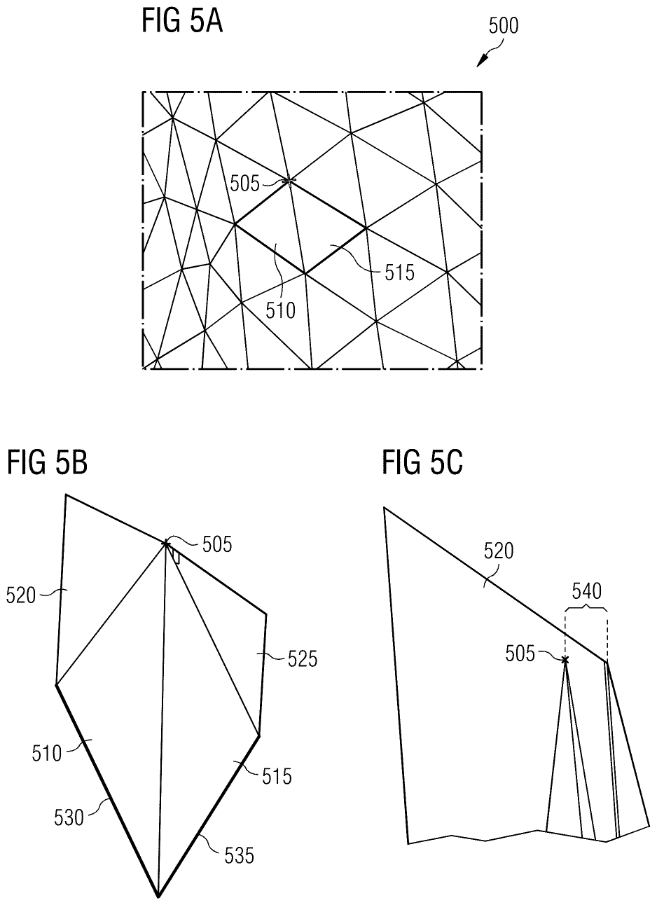

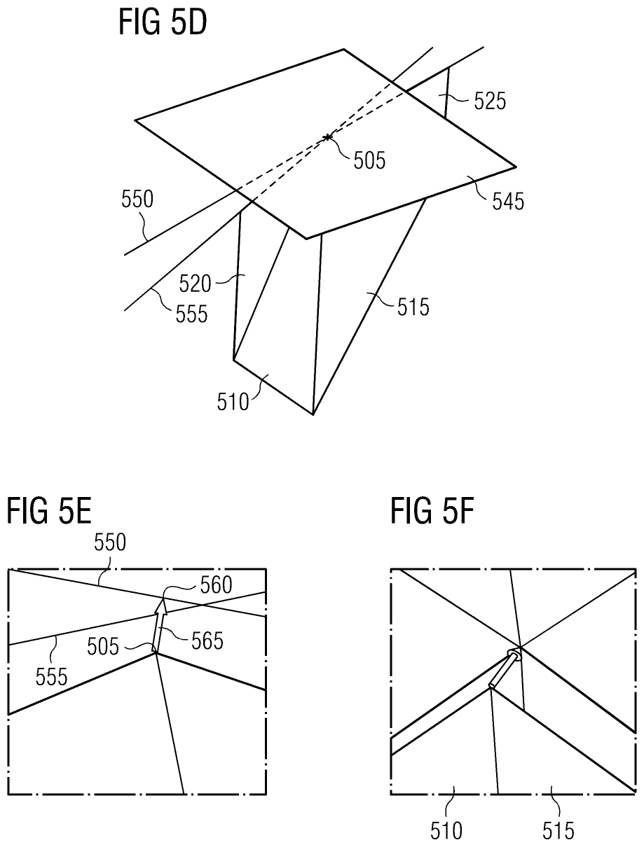

FIG. 5A shows an enlarged view 500 of a vertex 505 and facets 510, 515 in the region 440 of the mesh 410 from FIG. 4B. The facets 510, 515 contain the vertex 505 and are located below the vertex 505. Taper planes may be constructed on edges opposite to the vertex 505 on each of facets 510, 515. These taper planes may be used to determine how to adjust the position of vertex 505. The taper planes may be constructed on-the-fly.

FIG. 5B shows vertex 505, facets 510, 515, and taper planes 520, 525. The taper planes 520, 525 may be constructed on the edges 530, 535 opposite to the vertex 510. The taper planes 520, 525 may be constructed using the same swept cone method as the taper surface 150 in FIG. 1B, based on a draft angle, θ. In general, there may be a set of taper planes for a vertex corresponding to edges of facets located below the vertex.

FIG. 5C shows an enlarged view of the vertex 505 and taper planes 520, 525. In FIG. 5C, a gap 540 between the vertex 505 and taper planes 520, 525 is visible, which shows that the vertex 505 is to be moved to satisfy the taper constraint. In order to determine whether the vertex 505 satisfies the taper constraint, a similar method may be employed to the method previously described in the context of FIG. 3B. If the dot products of either of the facet normal vectors of facets 510, 515 with the corresponding normal vectors of the taper planes 520, 525 are positive, then the vertex 505 is identified as failing the taper constraint.

FIG. 5D shows the taper planes 520, 525 and facets 510, 515 for the vertex 505. In order to determine the adjustment for vertex 505, the taper planes 520, 525 are intersected with the plane 545 perpendicular to the pull direction vector, containing the vertex 505. This produces a pair of lines 550, 555 that lie in the plane 545. More generally, a set of lines may be obtained from intersecting each taper plane in the set of taper planes with the plane perpendicular to the pull direction vector.

FIG. 5E shows an enlarged view of lines 550, 555 and vertex 505. The closest point 560 on the line 555, which is the line furthest away from the vertex 505, provides a target point for computing an adjustment in the plane 545 to move the vertex 505. Once the target point 560 is identified, the vertex 505 may be adjusted in the direction 565 towards the target point 560. The amount of adjustment may be limited to a proportion of the distance between the vertex 505 and target point 560 to prevent distortion of the mesh. FIG. 5F shows an enlarged view of the facets 510, 515, before and after movement in the direction indicated by arrow 565.

In some cases, the facets that contain a selected vertex v and lie below v do not provide enough constraints to compute a suitable move for v that will provide that the vertex eventually satisfies the taper constraint. In such a case, facets that do not contain the vertex, but lie in the vicinity of the vertex, may be used to provide additional constraints.

Referring again to FIG. 2, once every vertex in the ordered list has been selected, at block 280, a determination is made whether the mesh satisfies the taper constraint. If all the facets in the mesh located above the parting sheet satisfy the taper constraint, then the mesh satisfies the taper constraint and the method terminates. If this is not the case, then the method 200 returns to block 230 and iterates through the ordered list of vertices again, identifying vertices that do not satisfy the taper constraint and adjusting the positions of those vertices. By performing multiple iterations in this fashion, the amount of mesh distortion by any single adjustment is limited. However, the vertices converge to positions where the mesh satisfies the taper constraint. The method respects topology optimization of the mesh by keeping the amount of adjustment as limited as possible.

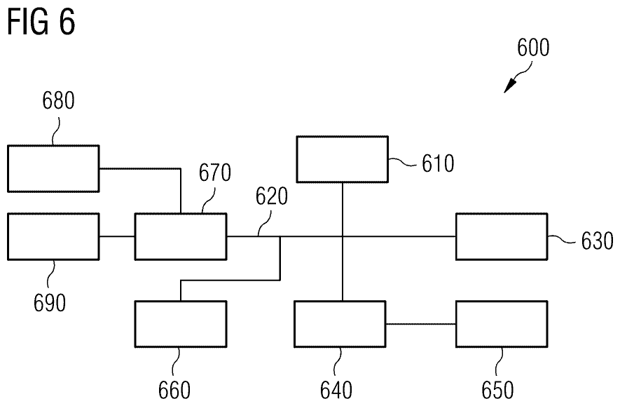

FIG. 6 illustrates an example of a data processing system in which an embodiment of the present disclosure may be implemented (e.g., a CAD or CAM application configured to perform the methods of the embodiments as described herein). The data processing system 600 includes a processor 610 connected to a local system bus 620. The local system bus connects the processor to a main memory 630 and a graphics display adaptor 640 that may be connected to a display 650. The data processing system 600 may communicate with other systems via a wireless user interface adapter connected to the local system bus 620, or via a wired network (e.g., to a local area network). Additional memory 660 may also be connected via the local system bus 620.

A suitable adaptor, such as wireless user interface adapter 670, for other peripheral devices, such as a keyboard 680 and mouse 690, or other pointing device, allows the user to provide input to the data processing system. Other peripheral devices may include one or more I/O controllers such as USB controllers, Bluetooth controllers, and/or dedicated audio controllers (e.g., connected to speakers and/or microphones). Various peripherals may be connected to the USB controller (e.g., via various USB ports) including input devices (e.g., keyboard, mouse, touch screen, trackball, camera, microphone, scanners), output devices (e.g., printers, speakers), or any other type of device that is operative to provide inputs or receive outputs from the data processing system.

The data processing system 600 is adapted to carry out the methods in accordance with the embodiments described herein. For example, the keyboard 680 and mouse 690 may function as a user input device for receiving information from the user, the processor 610 may be adapted to carry out the steps of the method, and the display 650 may be adapted to display a particular view to the user. A computer product including instructions that, when run on a computer, such as the data processing system 600, may be provided to cause the computer to execute the steps of the methods of the embodiments outlined above.

The present disclosure is described with reference to flow charts and/or block diagrams of the method, devices, and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary, and/or additional blocks may be added.

The present inventions may be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. A method of modifying a mesh to satisfy a taper constraint for a molding process, wherein the taper constraint specifies a draft angle and a pull direction vector relative to a parting surface, the method being computer-implemented and comprising:
accessing a representation of an object as a mesh in three-dimensional space, the mesh comprising a plurality of interconnected vertices forming one or more facets;
sorting the plurality of interconnected vertices into a height-ordered list, based on a distance of each vertex from the parting surface in a direction of the pull direction vector;
adjusting the position of one or more of the vertices; and
iteratively repeating the adjusting until the taper constraint is satisfied for every vertex in the mesh, wherein adjusting the position of one or more of the vertices comprises:
selecting a first vertex in the ordered list as a first selected vertex;
determining whether the first selected vertex satisfies the taper constraint;
when the first selected vertex fails to satisfy the taper constraint, adjusting the position of the first selected vertex in a plane perpendicular to the pull direction vector and containing the first selected vertex;
selecting a subsequent vertex in the ordered list as a next selected vertex; and
repeating the determining, the adjusting of the position for the next selected vertex, and the selecting of the subsequent vertex until every vertex in the ordered list has been selected.

2. The method of claim 1, wherein determining whether the selected vertex satisfies the taper constraint comprises:
determining whether a height of the selected vertex above the parting surface is above a predefined threshold;
applying a first method to determine whether the selected vertex satisfies the taper constraint, when the height of the selected vertex is above the predetermined threshold; and
applying a second method to determine whether the selected vertex satisfies the taper constraint, when the height of the selected vertex is below the predetermined threshold.

3. The method of claim 2, wherein the first method to determine whether the selected vertex satisfies the taper constraint comprises:
generating a set of taper planes for the selected vertex;
for each taper plane in the set of taper planes, determining whether the selected vertex satisfies the taper constraint for the taper plane;
identifying the selected vertex as failing the taper constraint when the selected vertex fails the taper constraint for one or more of the taper planes in the set, and otherwise, identifying the selected vertex as satisfying the taper constraint.

4. The method of claim 3, wherein generating the set of taper planes for the selected vertex comprises:
identifying facets in the mesh located below the selected vertex with respect to the pull direction vector; and
for each identified facet:
identifying one or more edges of the facet;
constructing a plane containing the edge, based on the draft angle; and
including the plane in the set of taper planes for the selected vertex.

5. The method of claim 3, wherein adjusting the position of the selected vertex comprises:
intersecting each taper plane with a plane perpendicular to the pull direction vector and containing the selected vertex to obtain a line;
including the line in a set of lines;
identifying a target position for the selected vertex based on the set of lines; and
adjusting the position of the selected vertex in a direction towards the target position.

6. The method of claim 5, wherein adjusting the position of the selected vertex comprises:
adjusting the position by a fraction, 1/c, of the direction towards the target position for a predefined constant value, c.

7. The method of claim 2, wherein the second method to determine whether the selected vertex satisfies the taper constraint comprises:
intersecting the parting sheet with the mesh to generate a set of parting curves;
obtaining a set of taper surfaces based on the set of parting curves;
identifying a taper surface associated with the selected vertex;
determining whether the selected vertex satisfies the taper constraint for the associated taper surface; and
identifying the selected vertex as failing the taper constraint when the selected vertex fails the taper constraint for the associated taper surface, and otherwise, identifying the selected vertex as satisfying the taper constraint.

8. The method of claim 7, wherein adjusting the position of the selected vertex comprises:
identifying a target position for the selected vertex based on the associated taper surface; and
adjusting the position of the selected vertex in a direction towards the target position.

9. The method of claim 8, wherein adjusting the position of the selected vertex comprises:
adjusting the position by a fraction, 1/c, of the direction towards the target position for a predefined constant value c.

10. The method of claim 7 wherein obtaining the set of taper surfaces based on the set of parting curves comprises, for each parting curve in the set of parting curves:
sweeping a cone along the parting curve to obtain an envelope surface; and
including the obtained envelope surface in the set of taper surfaces.

11. A system comprising:
a data processor; and
a memory storing instructions to modify a mesh to satisfy a taper constraint for a molding process, wherein the taper constraint specifies a draft angle and a pull direction vector relative to a parting surface, wherein the instructions cause the data processor to:
access a representation of an object as a mesh in three-dimensional space, the mesh comprising a plurality of interconnected vertices forming one or more facets;
sort the plurality of vertices into a height-ordered list, based on a distance of each vertex from the parting surface in a direction of the pull direction vector;
adjust a position of one or more of the vertices; and
iteratively repeat the adjustment until the taper constraint is satisfied for every vertex in the mesh, wherein to adjust the position of one or more of the vertices, the instructions cause the processor to:
select a first vertex in the ordered list as a first selected vertex;
determine whether the first selected vertex satisfies the taper constraint;
when the first selected vertex fails to satisfy the taper constraint, adjust the position of the first selected vertex in a plane perpendicular to the pull direction vector and containing the first selected vertex;
select the subsequent vertex in the ordered list as a next selected vertex; and
repeat the determination, the adjustment of the position of the selected vertex, and the selection of the subsequent vertex for the next selected vertex, until every vertex in the ordered list has been selected.

12. The system of claim 11, wherein for the determination of whether the selected vertex satisfies the taper constraint, the instructions cause the processor to:
determine whether a height of the selected vertex above the parting surface is above a predefined threshold;
apply a first method to determine whether the selected vertex satisfies the taper constraint when the height of the selected vertex is above the predetermined threshold; and
apply a second method to determine whether the selected vertex satisfies the taper constraint when the height of the selected vertex is below the predetermined threshold.

13. The system of claim 12, wherein the first method to determine whether the selected vertex satisfies the taper constraint causes the processor to:
generate a set of taper planes for the selected vertex;
for each taper plane in the set of taper planes, determine whether the selected vertex satisfies the taper constraint for the taper plane;
identify the selected vertex as failing the taper constraint when the selected vertex fails the taper constraint for one or more of the taper planes in the set, and otherwise, identify the selected vertex as satisfying the taper constraint.

14. The system of claim 13, wherein to generate the set of taper planes for the selected vertex, the instructions cause the processor to:
identify facets in the mesh located below the selected vertex with respect to the pull direction vector; and
for each identified facet:
identify one or more edges of the facet;
construct a plane containing the edge, based on the draft angle; and
include the plane in the set of taper planes for the selected vertex.

15. The system of claim 13, wherein to adjust the position of the selected vertex, the instructions cause the processor to:
intersect each taper plane with the plane perpendicular to the pull direction vector and containing the selected vertex to obtain a line;
include the line in a set of lines;
identify a target position for the selected vertex based on the set of lines; and
adjust the position of the selected vertex in a direction towards the target position.

16. The system of claim 15, wherein to adjust the position of the selected vertex, the instructions cause the processor to:
adjust the position by a fraction, 1/c, of the direction towards the target position v′, for a predefined constant value c.

17. The system of claim 12, wherein the second method to determine whether the selected vertex satisfies the taper constraint causes the processor to:
intersect the parting sheet with the mesh to generate a set of parting curves;
obtain a set of taper surfaces based on the set of parting curves;
identify a taper surface associated with the selected vertex;
determine whether the selected vertex satisfies the taper constraint with respect to the associated taper surface; and
identify the selected vertex as failing the taper constraint when the selected vertex fails the taper constraint for the associated taper surface, and otherwise, identify the selected vertex as satisfying the taper constraint.

18. The system of claim 17, wherein to adjust the position of the selected vertex, the instructions cause the processor to:
identify a target position for the selected vertex based on the associated taper surface; and
adjust the position of the selected in a direction towards the target position.

19. The system of claim 18, wherein to adjust the position of the selected vertex, the instructions cause the processor to:
adjust the position by a fraction, 1/c, of the direction towards the target position, for a predefined constant value c.

20. The system of claim 17, wherein to obtain a set of taper surfaces based on the set of parting curves, the instructions cause the processor, for each parting curve in the set of parting curves, to:
sweep a cone along the parting curve to obtain an envelope surface; and
include the obtained envelope surface in the set of taper surfaces.
